(19) United States
(12) Patent Application Publication
(10) Pub. No.: US 2009/0190273 A1
(43) Pub. Date: Jul. 30, 2009

(54) Ultracapacitor Overvoltage Protection Circuit With Self Verification

(75) Inventors: Brian D. Moran, La Mesa, CA (US); Michael D. Wilk, Temecula, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE Corporation, Poway, CA (US)

(21) Appl. No.: 12/414,275

(22) Filed: Mar. 30, 2009

Related U.S. Application Data
(63) Continuation-in-part of application No. 12/237,529, filed on Sep. 25, 2008.
Application No. 12/237,529 is a continuation-in-part of application No. 11/460,738, filed on Jul. 28, 2006.
Application No. 11/460,738 is a continuation of application No. 10/720,916, filed on Nov. 24, 2003, now Pat. No. 7,085,112.
Application No. 10/720,916 is a continuation-in-part of application No. 09/972,085, filed on Oct. 4, 2001, now Pat. No. 6,714,391.

(51) Int. Cl. H02H 7/16

(52) U.S. Cl. 361/16; 903/904; 903/907

(57) ABSTRACT

A system and method for protecting a hybrid electric vehicle propulsion energy storage pack from an overvoltage condition is described. The energy storage pack includes a plurality of energy storage cells electrically connected in series and electrically coupled with a vehicle direct current (DC) bus. The system includes one or more overvoltage detection circuits, a disconnect circuit and one or more connection verification circuits. The one or more voltage detection circuits detect an overvoltage condition across a subset of the plurality of energy storage cells. The disconnect circuit electrically decouples the energy storage pack from the DC power bus upon detection of an overvoltage condition across the subset of the plurality of energy storage cells. The one or more connection verification circuits verify that the overvoltage detection circuit is electrically coupled to the subset of the plurality of energy storage cells.

### CROSS-REFERENCE TO RELATED APPLICATIONS

This patent application is a continuation-in-part of U.S. patent application Ser. No. 12/237,529, filed Sep. 25, 2008, which is a continuation-in-part of U.S. patent application Ser. No. 11/460,738, filed Jul. 28, 2006, which is a continuation of U.S. patent application Ser. No. 10/720,916, filed Nov. 24, 2003, issued as U.S. Pat. No. 7,085,112 on Aug. 1, 2006, which is a continuation-in-part application of U.S. patent application Ser. No. 09/972,085, filed Oct. 4, 2001, issued as U.S. Pat. No. 6,714,391 on Mar. 30, 2004. These applications/patents are incorporated by reference herein as though set forth in full.

### FIELD OF THE INVENTION

This invention relates to hybrid electric vehicles (HEVs) and high power electric drive systems. In particular, the field of the invention relates to components specially adapted for HEVs including systems and methods for protecting a propulsion energy storage pack from an overvoltage condition.

### BACKGROUND OF THE INVENTION

A hybrid electric vehicle (HEV) is a vehicle which combines a conventional propulsion system with an on-board rechargeable energy storage system to achieve better fuel economy and cleaner emissions than a conventional vehicle. While HEVs are commonly associated with automobiles, heavy-duty hybrids also exist. In the U.S., a heavy-duty vehicle is legally defined as having a gross weight of over 8,500 lbs. A heavy-duty HEV will typically have a gross weight of over 10,000 lbs. and may include vehicles such as a metropolitan transit bus, a refuse collection truck, a semi tractor trailer, etc.

In a parallel configuration (not shown), an HEV will commonly use an internal combustion engine (ICE) to provide mechanical power to the drive wheels and to generate electrical energy. The electrical energy is stored in an energy storage device, such as a battery pack or an ultracapacitor pack, and may be used to assist the drive wheels as needed, for example during acceleration.

Referring to FIG. 1, in a series configuration, an HEV drive system 100 will commonly use an energy generation source such as an “engine genset” 110 comprising an engine 112 (e.g., ICE, H-ICE, CNG, LNG, etc.) coupled to a generator 114, and an energy storage pack or module 120 (e.g., battery, ultracapacitor, flywheel, etc.) to provide electric propulsion power to its drive wheel propulsion assembly 130. In particular, the engine 112 (here illustrated as an ICE) will drive generator 114, which will generate electricity to power one or more electric propulsion motor(s) 134 and/or charge the energy storage 120. Energy storage 120 may solely power the one or more electric propulsion motor(s) 134 or may augment power provided by the engine genset 110. Multiple electric propulsion motor(s) 134 may be mechanically coupled via a combining gearbox 133 to provide increased aggregate torque to the drive wheel assembly 132 or increased reliability. Heavy-duty HEVs may operate off a high voltage electrical power system rated at over 500 VDC. Propulsion motor(s) 134 for heavy-duty vehicles (here, having a gross weight of over 10,000) may include two AC induction motors that produce at least 85 kW of power (×2) and having a rated DC voltage of 650 VDC.

Unlike lower rated systems, heavy-duty high power HEV drive system components may also generate substantial amounts of heat. Due to the high temperatures generated, high power electronic components such as the generator 114 and electric propulsion motor(s) 134 will typically be cooled (e.g., water-glycol cooled), and may also be included in the same cooling loop as the ICE 112.

Since the HEV drive system 100 may include multiple energy sources (i.e., engine genset 110, energy storage device 120, and drive wheel propulsion assembly 130 in regen—discussed below), in order to freely communicate power, these energy sources may then be electrically coupled to a power bus, in particular a DC high power bus 150. In this way, energy can be transferred between components of the high power hybrid drive system as needed.

An HEV may further include both AC and DC high power systems. For example, the drive system 100 may generate, and run on, high power AC, but it may also convert it to DC for storage and/or transfer between components using the DC high power bus 150. Accordingly, the current may be converted via an inverter/rectifier 116, 136 or other suitable device (hereinafter “inverters” or “AC-DC converters”). Inverters 116, 136 for heavy-duty vehicles are costly, specialized components, which may include a special high frequency (e.g., 2-10 kHz) IGBT multiple phase water-glycol cooled inverter with a rated DC voltage of 650 VDC and having a peak current of 300 A.

As illustrated, HEV drive system 100 includes a first inverter 116 interspersed between the generator 114 and the DC high power bus 150, and a second inverter 136 interspersed between the generator 134 and the DC high power bus 150. Here the inverters 116, 136 are shown as separate devices, however it is understood that their functionality can be incorporated into a single unit.

As a key added feature of HEV efficiency, many HEVs recapture the kinetic energy of the vehicle via regenerative braking rather than dissipating kinetic energy via friction braking. In particular, regenerative braking (“regen”) is where the electric propulsion motor(s) 134 are switched to operate as generators, and a reverse torque is applied to the drive wheel assembly 132. In this process, the vehicle is slowed down by the electric propulsion motor(s) 134, which converts the vehicle's kinetic energy to electrical energy. As the vehicle transfers its kinetic energy to the motor(s) 134, now operating as a generator(s), the vehicle slows, and electricity is generated and stored. Later, when the vehicle needs this stored energy for acceleration or other power needs, it is released by the energy storage 120.

This is a particularly valuable feature for vehicles whose drive cycles include a significant amount of stopping and acceleration (e.g., metropolitan transit buses). Regenerative braking may also be incorporated into an all-electric vehicle (EV) thereby providing a source of electricity generation onboard the vehicle.

When the energy storage 120 reaches a predetermined capacity (e.g., fully charged), the drive wheel propulsion assembly 130 may continue to operate in regen for efficient braking. However, instead of storing the energy generated, any additional regenerated electricity may be dissipated through a resistive braking resistor 140. Typically, the braking resistor 140 will be included in the cooling loop of the ICE 112, and will dissipate the excess energy as heat.

Focusing on the vehicle's energy storage, the energy storage pack or module 120 may be made up of a plurality of energy storage cells 122. The plurality of energy storage cells 122 may be electrically coupled in series, increasing the packs voltage. Alternately, energy storage cells 122 may be electrically coupled in parallel, increasing the packs current, or both in series and parallel.

When an energy storage cell (e.g., an ultracapacitor) is faulty or damaged it may have an increased equivalent series resistance (ESR). In this situation, if the pack continues to deliver/receive the same current, the voltage across the failed ultracapacitor will increase. This increased voltage may cause further deterioration, and lead to poor performance and increased ESR across the bad cell. Ultimately the cell may fail all together. A failure of just one cell may then lead to the loss of the entire energy storage pack and/or catastrophic loss to the vehicle.

Due to the harsh mobile environment/conditions where ultracapacitor packs operate, it is possible that an overvoltage protection circuit can lose its connection (e.g., a broken wire, detached connector, solder joint failure, etc.). If this occurs the overvoltage protection system may not operate, and lead to a false indication of proper operation, an unnoticed diminished performance, and/or catastrophic failure.

### SUMMARY

The present invention includes a system and method for protecting a hybrid electric vehicle propulsion energy storage pack from an overvoltage condition, the energy storage pack including a plurality of energy storage cells electrically connected in series and electrically coupled with a vehicle direct current (DC) bus. The system includes one or more overvoltage detection circuits, a disconnect circuit and one or more connection verification circuits. The one or more voltage detection circuits detect an overvoltage condition across a subset of the plurality of energy storage cells. The disconnect circuit may electrically decouple the energy storage pack from the DC power bus upon detection of an overvoltage condition across the subset of the plurality of energy storage cells and/or limit the voltage on the DC bus. The one or more connection verification circuits verify that the overvoltage detection circuit is electrically coupled to the subset of the plurality of energy storage cells.

In another embodiment, an overvoltage protection system specially adapted to protect an energy storage pack for a hybrid electric vehicle is described. The energy storage pack includes a plurality of energy storage cells grouped into a plurality of strings, each of the strings having a string positive node and a string negative node, an electrical interface with the hybrid electric vehicle coupled to the plurality of energy storage cells and configured to deliver electrical energy to and from the plurality of energy storage cells. The overvoltage verification system includes a communication interface with the hybrid electric vehicle, an energy storage pack communication bus, a plurality of overvoltage protection circuits and a connection verification circuit. The energy storage pack communication bus is communicatively coupled to the communication interface with the hybrid electric vehicle. Each of the plurality of overvoltage protection circuits is singularly electrically coupled to one of the plurality of strings and communicatively coupled to the energy storage pack communication bus. Each of the plurality of overvoltage protection circuits registers voltage across the string positive node and string negative node of its respective string's. The plurality of overvoltage protection circuits further communicates an overvoltage condition to the energy storage pack communication bus. The connection verification circuit verifies that each of the plurality of overvoltage protection circuits is electrically coupled to one of the plurality of strings.

In yet another embodiment, a method for protecting an energy storage pack or module from an overvoltage condition of a hybrid electric vehicle is described. The energy storage module includes a plurality of energy storage cells that may be electrically connected in series and electrically coupled with a vehicle direct current (DC) bus. The process starts with verifying whether an overvoltage detection circuit is electrically coupled to the subset of the plurality of energy storage cells by a connection verification circuit. The method then continues to a second step detecting an overvoltage condition across a subset of the plurality of energy storage cells by a voltage detection circuit. Finally the energy storage pack is electrically decoupled from the DC power bus upon the detection of an overvoltage condition across the subset of the plurality of energy storage cells by a disconnect circuit, or alternately upon detection that an overvoltage detection circuit is not properly functioning.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a schematic diagram illustrating an embodiment of drive components of a hybrid electric vehicle in a series configuration;

FIG. 2 illustrates a functional schematic diagram of an embodiment of an overvoltage protection system adapted to protect an energy storage pack for a hybrid electric vehicle;

FIG. 3 is a schematic diagram illustrating an embodiment of an overvoltage protection system adapted to protect a string of energy storage cells for a hybrid electric vehicle;

FIG. 4 is a flow chart of an exemplary method for protecting an energy storage pack or module from an overvoltage condition of a hybrid electric vehicle.

### DETAILED DESCRIPTION

The invention is directed toward a robust, low-cost, self-sustaining overvoltage protection system to detect whether a vehicle propulsion electric energy storage pack has experienced an overvoltage condition and whether or not an overvoltage detection circuit is connected and/or faulty. In general, a connection verification circuit is normally on when the overvoltage detection circuit is properly connected, thus closing a verification signal loop. If the overvoltage detection/protection circuit becomes faulty or disconnected, the connection verification circuit may send a signal to a controller, for example a system controller or module controller, indicating the fault or disconnect. Through early detection and reporting, the pack may be electrically removed from the drive system and damage may then be prevented.

After reading this description, it will become apparent to one skilled in the art how to implement the invention in various alternative embodiments and alternative applications. Although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

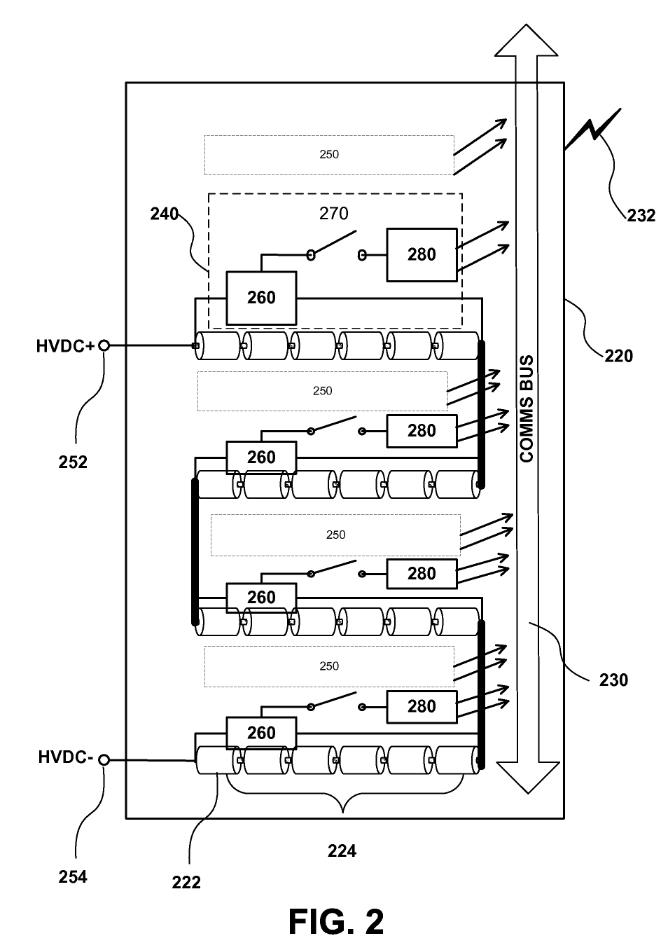

Referring now to FIG. 2, there is seen a functional schematic conceptually illustrating one embodiment of an overvoltage protection system adapted to protect an energy storage pack for a hybrid electric vehicle. In particular, energy storage pack 220 is shown comprising a plurality of energy storage cells 222 electrically coupled in series, a communications bus 230, a communication interface 232 with the vehicle, a “positive” high voltage DC terminal 252 electrically coupled to the “high” side of the plurality of energy storage cells 222, and a “negative” high voltage DC terminal 254 electrically coupled to the “low” side of the plurality of energy storage cells 222. High voltage DC terminals 252, 254 may then be selectably coupled to a vehicle DC bus 150 (not shown). Within energy storage pack 220 the plurality of energy storage cells 222 are shown conveniently grouped in strings 224 of energy storage cells 222 wherein each string 224 has its own overvoltage protection circuit 240.

Overvoltage protection or detection circuit 240 may include detection circuit 260, on/off circuitry 270, and reporting circuit 280. In operation, the overvoltage protection circuitry 240 will detect an overvoltage condition, trigger an on/off device, and report the overvoltage condition to the vehicle. It is understood that, while overvoltage protection circuitry 240 is conveniently illustrated as discrete elements (260, 270, 280) to aid in understanding the concept of the invention, this exemplary configuration is not limiting. For example, circuit elements 260, 270, 280 may utilize shared components, or may be considered as a combination including the components illustrated.

A connection verification circuit 250 can be coupled to the overvoltage detection circuit 240. The connection verification circuit 250 may be independent or integrated with the overvoltage detection circuit 240. However, connection verification circuit 250 will be configured such that in operation, the connection verification circuit 250 will detect a disconnected or faulty overvoltage protection or detection circuit 240 and report the fault or disconnection to the vehicle or a controller. The connection verification circuit may be implemented as discrete elements, shared components, software, firmware or may be considered as a combination thereof.

Although string 224 is illustrated as including six energy storage cells 222, this is merely one exemplary embodiment, and is no way limiting. Rather, the number of energy storage cells 222 may vary from application to application. For example, at one extreme, an energy storage pack 220 may have overvoltage protection that utilizes a circuit that compares a voltage across the entire energy storage pack 220 (i.e., a single string of all the cells) to a threshold voltage, setting an alarm if the measured voltage exceeds the threshold. At the other extreme an overvoltage protection circuit may be applied to each cell. Preferably, overvoltage detection circuit 240 will address a subset or string 224 of the energy storage cells 222, as illustrated.

Likewise, a corresponding connection verification circuit 250 may be connected to the different implementations of the overvoltage protection or detection circuit. For example, one or more connection verification circuits 250 may be connected to each overvoltage detection circuit 240. In other embodiments a single connection verification circuit 250 may be connected to multiple overvoltage detection circuits 240.

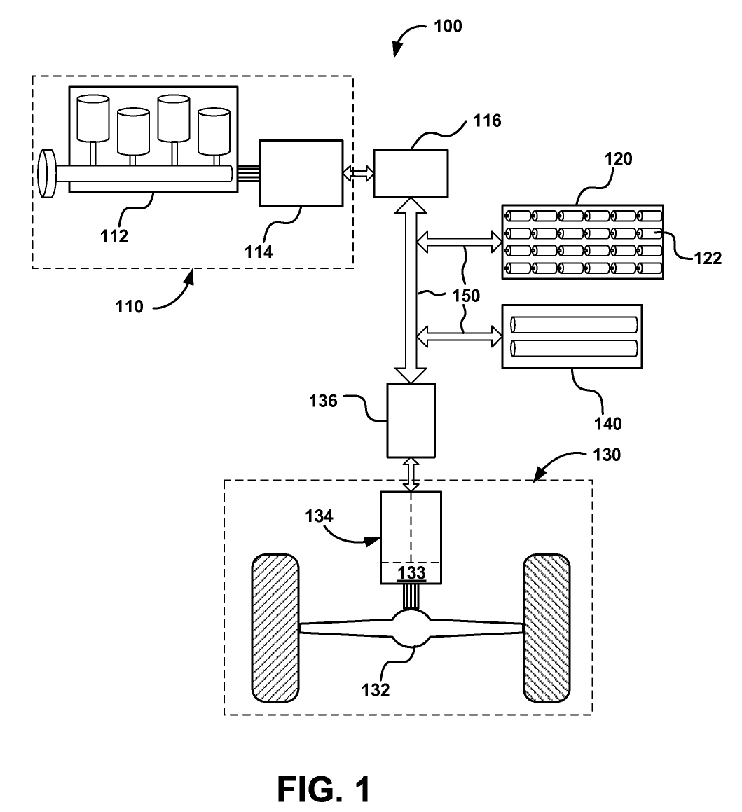

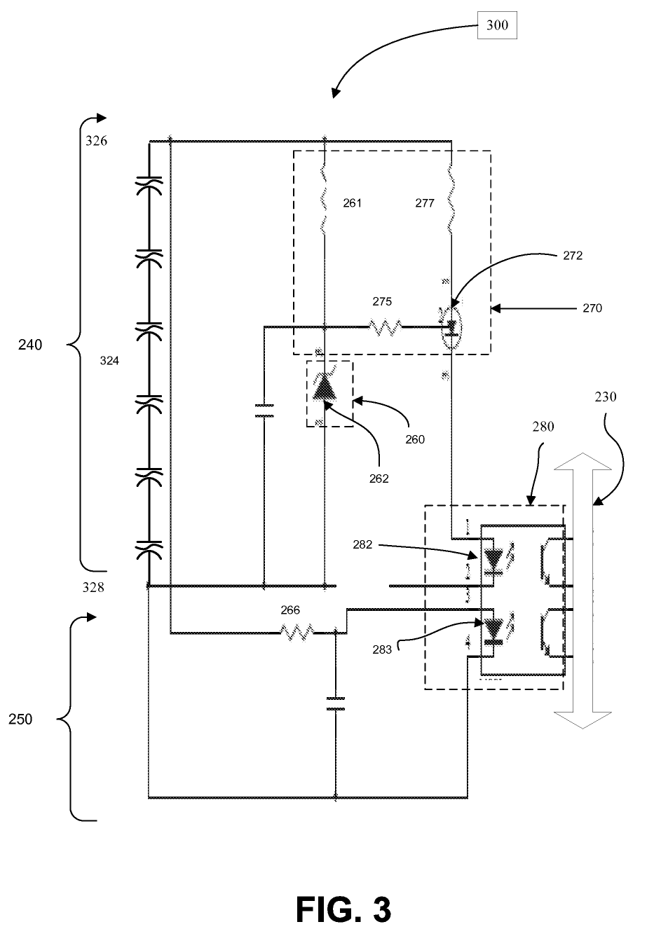

FIG. 3 illustrates one example of an overvoltage protection system adapted to protect a string of energy storage cells for a hybrid electric vehicle according to one embodiment. This string protection may be employed throughout an entire propulsion energy storage pack. In addition, this illustrated string overvoltage protection system 300 may be integrated with others to form a pack overvoltage protection system or protection network. For explanatory purposes, FIG. 3 will be discussed with reference to FIGS. 1 and 2 as well.

The overvoltage protection system 300 may include a positive node 326 and a negative node 328 in which the overvoltage protection system 300 may interface with the plurality of storage cells 222. The plurality of storage cells may be battery based or ultracapacitor based and can be grouped together to form one or more strings 224. The one or more strings 224 of energy storage cells 222 may be electrically connected in series at the positive node 326 and a negative node 328, and together, be electrically coupled with the vehicle direct current bus 150 via “positive” high voltage DC terminal 252 and “negative” high voltage DC terminal 254.

Each string 224 may include a variable number of energy storage cells 222 depending on the application. Also, the pack 220 may include a variable total number of energy storage cells 222, depending on the application and the required output voltage. For example, in some heavy-duty hybrid applications, the energy storage pack or module 220 may have a rated voltage of at least 500V direct current (VDC) and require 144 energy storage cells.

As illustrated, the overvoltage protection system 300 may include overvoltage detection circuit 240, connection verification circuit 250, and be communicably coupled to communication bus 230. As discussed above, multiple overvoltage protection systems 300 may be employed throughout an entire propulsion energy storage pack and integrated with others to form a single overvoltage protection system for the pack.

One or more overvoltage detection circuits 240 of a pack are configured to detect and report an overvoltage condition across at least a subset of the plurality of energy storage cells 222 (e.g., a string). In addition, one or more connection verification circuits 250 are configured to verify that the one or more overvoltage detection circuits are electrically coupled to the subset of the plurality of energy storage cells.

As previously described, the overvoltage protection circuit 240 may include detection circuit 260, on/off circuit 270, reporting circuit 280, and an interface to the positive node 326 and negative node 328 of the plurality of energy storage cells 222. Here, and throughout this disclosure, circuits or circuitry may be implemented as hardware, software, and/or a combination of both.

The detection circuit 260 may include a voltage reference or voltage activated conductor that will conduct current once a predetermined triggering potential is reached across the positive node 326 and the negative node 328. For example, the detection circuit 260 may include a Zener diode 262 (or an avalanche diode) electrically coupled as illustrated to the positive node 326 and the negative node 328, and in parallel with string 224, wherein the Zener diode 262 is configured to register voltage across positive node 326 and the negative node 328. A Zener diode is a type of diode that permits current to flow in the forward direction like a normal diode, but also in the reverse direction if the voltage is larger than the breakdown voltage. In this way, voltage may also be regulated at the breakdown voltage. Under normal operating conditions the potential difference between string nodes 326 and 328 will be less than the trigger voltage of Zener 262. Accordingly, no current will flow through the Zener 262. Thus, prior to an overvoltage condition, no current will flow through detection circuitry 260. However, once an overvoltage condition occurs, Zener 262 will create a current path, which may be used to activate and power the overvoltage protection circuitry 240. Additionally, a resistor 261 (R3) may be selected and positioned before Zener 262 so as to limit the current passing through the newly created current path.

The reporting circuit 280 may include an isolator that is electrically coupled to overvoltage protection circuit 240 and the connection verification circuit 250 and communicatively coupled to the communications bus 230. For example, the reporting circuit 280 may include one or more galvanic isolators/opto-isolators 282 electrically coupled to overvoltage protection circuit 240 and optically coupled to communications bus 230. An opto-isolator (or optical isolator, optocoupler, photocoupler, or photoMOS) is a device that uses a short optical transmission path to transfer a signal between elements of a circuit, typically a transmitter and a receiver, while keeping them electrically isolated -since the signal goes from an electrical signal to an optical signal back to an electrical signal, electrical contact along the path is broken. Similarly, a galvanic isolator/opto-isolators 283 may be coupled with the connection verification circuit 250 such that there is no electrical current flowing directly from overvoltage protection system 300 to the communication bus 230, while energy and/or information can still be exchanged between the sections by other means, however, such as by capacitance, induction, electromagnetic waves, optical, acoustic, or mechanical means. Thus, signals associated with an overvoltage condition may be provided to the vehicle communication interface without exposing it to the vehicle's high voltage system.

The on/off circuit 270 may be configured to persistently communicate the overvoltage condition to the communication bus 230 once the overvoltage condition occurs. This is in contrast to a communication that terminates once the overvoltage condition has returned below the threshold voltage. The on/off circuit 270 is normally-off or remains off (e.g., “open”) while there is no overvoltage condition across string 224, but triggers or turns on (e.g., “close”) and remains on once an overvoltage condition has occurred. Thus, overvoltage protection circuit 240 may send a persistent signal that “remembers” that a failure occurred. For example, a brief or intermittent fault, which may have otherwise gone unnoticed and never realized, becomes visible and corrective action may occur. This is particularly beneficial where one cell has deteriorated enough that the string voltage is floating near the threshold voltage, yet does not remain out of spec for sufficient time to register the fault. Moreover, by being notified of an intermittent fault, this feature better aids the vehicle to take remedial action immediately and/or vehicle maintenance personnel to prevent an oncoming failure in advance.

In one embodiment, on/off circuitry 270 may include a transistor 272 such as a Programmable Unijunction Transistor (PUT). A PUT 272 behaves much like a unijunction transistor (UJT), but is “programmable” via external resistors (that is, you can use two resistors 277 (R1) & 275 (R2) to set a PUT's peak voltage). A PUT is a three-terminal thyristor that is triggered into conduction when the voltage at the anode exceeds the voltage at the gate. The PUT then remains in conduction, independent of gate voltage, until the current across the anode and cathode dips below the valley current—typically a nominal value. In a programmable unijunction transistor, operating characteristics such as base-to-base resistance, intrinsic standoff voltage, valley current, and peak current can be programmed by setting the values of two external resistors 277 (R1) & 275 (R2).

In operation herein, PUT 272 will trigger once the voltage at its anode is greater than at its gate. Under normal (untriggered) conditions Zener 262 and PUT 272 do not pass current. Accordingly, the voltage at PUT 272 anode and gate will be the same. At the overvoltage condition however, current begins to pass through Zener 262 and voltage difference can be realized. Note, as illustrated here, and with regard to resistance, R1<(R2+R3). Accordingly, once Zener 262 is fired, the voltage at the anode of PUT 272 will exceed its gate voltage and PUT 272 will turn on hard. At this point two things happen; first, opto-isolator 282 will begin communicating the fault to the ultracapacitor pack communications bus 230, and second, PUT 272 will persist on until the current across it dips below the valley current. Thus, the PUT transistor 272 will be triggered when the Zener diode 262 reaches its breakdown voltage and will allow the opto-isolator 282 to send, and continue to send, voltage-independent signals to a multiplexer, which can then be later used to indicate a fault condition in the ultracapacitor string 224 to a controller and/or to the vehicle.

According to an alternate embodiment, on/off circuitry 270 may also include precautions against false triggers. For example, a resistor R4 (not shown) between PUT 272 and string negative node 328, forms a resistor divider and bypasses optoisolator 282 to reduce false triggers. The value of R4 will vary from application to application, however it should generally be on the order of R4=R1/((Vstring/(Vz+Vput))−1), where Vstring is the voltage across string 224, Vz is the breakdown voltage across the Zener 262, and Vput is the trigger voltage across the anode and the gate of PUT 272. This helps set voltage at the PUT 272 anode and resists false triggers.

The overvoltage protection circuitry 240 does not require an external power supply, but rather is self-powered. In this way, overvoltage protection circuitry 240 is self-sustaining and not subject to failure from a loss of external power. Moreover, overvoltage protection circuitry 240 will have operational power so long as the overvoltage condition exists. Similarly, this configuration reduces system complexity by obviating the need for external power supply circuitry. Another benefit of this passive configuration is that little or no power is consumed during normal operation. This is because overvoltage protection circuitry 240 “sees” the combination of Zener 262 and PUT 272 as configured as an open circuit. Only after a fault, does current pass.

The connection verification circuit 250 complements the overvoltage protection circuit 240 described above by detecting and reporting when the overvoltage protection circuit 240 is faulty and/or is disconnected. The mobile vehicular environment is harsh on electronics. This is particularly true with heavy-duty vehicles, which often have long and/or arduous drive cycles. Vibration and contaminants alone may prematurely deteriorate onboard electronics. In addition, the power levels of propelling a heavy-duty hybrid may generate high heat in its electronic components, particularly the propulsion energy storage. The inventors have discovered that these conditions may affect onboard protection circuitry in an unpredictable fashion. A faulty or disconnected overvoltage protection circuit 240 may not operate, lead to a false sense of proper operation, lead to unnoticed diminished performance and/or lead to catastrophic failure. Accordingly, by indicating whether or not the overvoltage protection circuit 240 is even connected and functioning properly, remedial and/or preventative measures may be taken in response.

The connection verification circuit 250 is self-sustaining and independent of the vehicle's low voltage system. In particular, connection verification circuit 250 is powered by the plurality of energy storage cells 222 themselves. Connection verification circuit 250 interfaces to and shares positive node 326 and negative node 328 of the plurality of energy storage cells 222 with overvoltage protection circuit 240 as its voltage supply. Preferably, both overvoltage protection circuit 240 and connection verification circuit 250 are integrated (e.g., in an IC having a single interface with the energy storage cell string) such that the disconnection of the overvoltage protection circuit 240 will necessarily include the disconnection of the connection verification circuit 250.

In greater detail, the connection verification circuit 250 may be implemented as a circuit in parallel with overvoltage protection circuit 240. Although connection verification circuit 250 is not limited to any particular configuration, it is preferably at least in parallel with the detection circuit 260 (e.g., Zener diode 262) of the overvoltage protection circuit 240. Moreover, as illustrated in FIG. 3, connection verification circuit 250 may be electrically coupled in parallel with the entire overvoltage protection circuit 240, with both interfacing at shared positive node 326 and negative node 328.

Similar to the overvoltage protection circuit 240, the connection verification circuit 250 will include an electrical isolator configured to transmit isolated signals and separate the hybrid vehicle's high power propulsion system (e.g., 700 VDC) and from its low voltage communication system (24 VDC). This may be accomplished using an opto-isolator 283 similar to opto-isolator 282. Opto-isolator 283 may be a discrete device or may be integrated with opto-isolator 282. For example and as illustrated, connection verification circuit 250 includes opto-isolator 283 which transmits an optical signal (e.g., using the emission of an LED) to a collector (e.g., a phototransistor), completing a signaling circuit. In this embodiment the connection verification circuit 250 uses the voltage across the energy storage cells 222 to power the normally-on LED when the overvoltage detection circuit is connected or operational. The phototransistor will then close a signal verification loop. Here, the electrical isolator or optoisolator 283 electrically isolates communications between the connection verification circuit 250 and the communication bus 230. When the connection verification circuit 250 is no longer powered, the power to the LED is shut off and the signal verification loop is opened, thus indicating a disconnected or faulty overvoltage protection circuit as well.

According to one alternate embodiment, the LED may be optically multiplexed with optoisolator 282. Optoisolator 282 is part of the reporting circuit 280, which reports the fault or disconnection condition to a controller, for example, via the communication bus 230. By multiplexing the electrical isolators only a single collector is needed. This eliminates the redundancy occurring when overvoltage protection circuit 240 persistently transmits the overvoltage condition, which necessarily must be connected to the energy storage cells 222 in order to signal.

The communication bus 230 may take many forms and may be independent with regard to the overvoltage protection circuit 240. Preferably, after isolation, optoisolator 283 will close a single line and close its link of the series circuits, indicating that all connection verification circuits 250 are powered. Overvoltage protection circuit 240 may then communicate over a separate line of communication bus 230. Alternately, all connection verification circuits 250 may form the closed loop, and overvoltage protection circuit 240 may then communicate signals over the same line or closed circuit.

In one embodiment, the signal sent from the signal multiplexer can be selected such that a controller, (e.g., a system controller and/or a pack or module controller), interpreting the signals can distinguish between an overvoltage condition and when the overvoltage protection circuit 240 becomes disconnected or is faulty such as open circuit condition. This may be accomplished using hardware. For example, the shared multiplexer can include a resistor bridge such that the overvoltage signal will result in a different voltage than a closed circuit signal. Alternately, the resistor bridge may be configured such that the overvoltage signal coming from overvoltage protection circuit 240 is distinguishable from an overvoltage signal coming another string, or subset of strings. For example, the signal multiplexer may be configured such that, the connection verification circuit 250 and the overvoltage protection circuit 240 may share a single I/O to/from the energy storage pack or module 220. In particular, the signal multiplexer may transmit a first signal (e.g., V1) representing a “no-fault” condition, a second signal (e.g., V2) representing a “fault” condition and a third signal (e.g., V3) to distinguish between an overvoltage condition and a disconnected or faulty circuit. As discussed above V3 may be varied to indicate which string or subset of strings reported the overvoltage condition.

Preferably, connection verification circuit 250 will also include current conditioning. For example the circuit may include a current limiting device such as a series resistor, and a current stabilization device such as a capacitor in parallel with the opto-isolator 283. As illustrated, since connection verification circuit 250 is normally-on, resistor 266 (R5) may be selected and positioned before opto-isolator 283 so as to limit the current passing through the circuit to minimize the circuit current and the resultant drain on the energy storage cells 222. Similarly, capacitor 267 may be selected and positioned in parallel with opto-isolator 283 so as to filter the current passing through the circuit and minimize spikes and false readings from being transmitted to the vehicle.

As discussed above, the connection verification circuit 250 is normally-on when there is a voltage supplied to both it and the overvoltage protection circuit 240, and uses the supplied voltage to close a signal verification loop. In particular, in some embodiments, each individual connection verification circuit 250 is coupled in series (post-isolation) so that when one connection verification circuit 250 is faulty or disconnected, the chain or signal verification loop is broken and a connection fault may be registered and communicated to a controller or user interface. Accordingly, connection verification circuit 250 may be configured such that it sends a constant “on” signal indicating that there is a supply voltage across overvoltage protection circuit 240 and itself. Once activated, overvoltage protection circuit 240 will also provide this indication independently, since its firing will result in a persistent signal. After that point, a subsequent loss of supply voltage will then result in a loss of signal from both overvoltage protection circuit 240 and connection verification circuit 250.

In operation, if supply voltage is compromised, or the overvoltage protection circuit 240 becomes disconnected or is faulty, the verification circuit will send a signal to the controller, to report the fault and/or disconnection. The controller preferably includes a processor or circuitry configured to receive and interpret the signals transmitted by the overvoltage protection system 300. The signals may be merely applied voltages that correspond to a predetermined condition. For example, an open circuit may signal a faulty overvoltage protection circuit 240, whereas a V4 may signal an overvoltage condition has occurred on string #4.

The controller may further include a processor configured to digitize information communicated over the energy storage pack communication bus. Moreover, the controller may be further configured to communicate information communicated over the energy storage pack communication bus according to a standardized communications protocol associated with the vehicle communication bus. For example, the controller may take isolated signals (e.g., discrete or analog) communicated from the connection verification circuit 250 and convert them into CAN (Controller Area Network) messages that may then be communicated over a vehicle CAN network for further operations in response. It is understood that a controller may be also be used to communicate isolated signals from the overvoltage protection circuit 240 separately or in combination with signals from the connection verification circuit 250.

With regard to a series circuit of multiple connection verification circuits 250 (verifying multiple overvoltage protection circuits 240), a disconnect signal may be inferred by the controller as an interruption of the “connected” signal, which is normally on. This interpretation of the interruption of a normally-on signal may then be used to cause a reporting signal or other remedial action. For example, according to one embodiment, the controller interprets the signal and generates a message to a user interface or to an administrator to report the fault.

In other embodiments, the controller is configured to generate a responsive action when a failure to determine whether the overvoltage detection circuit 240 is connected to the plurality of energy storage cells 222. The responsive action can include disconnecting the plurality of energy storage cells from the DC power bus 150. In some embodiments, an LED or other indicator may be provided on a user interface to indicate a fault condition on the overvoltage protection circuit 240.

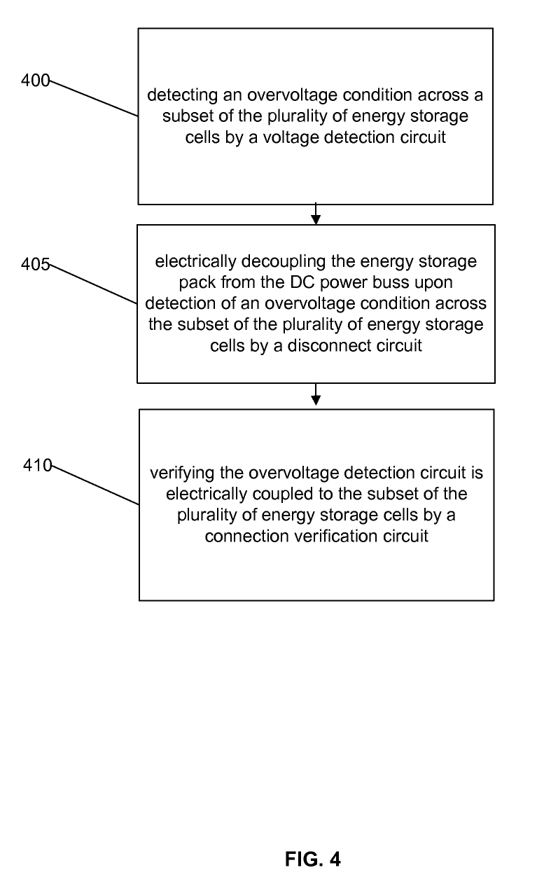

FIG. 4 is a flow chart of an exemplary method for protecting an energy storage pack or module from an overvoltage condition of a hybrid electric vehicle. In one embodiment, the energy storage module includes a plurality of energy storage cells. The plurality of energy storage cells may be electrically connected in series and electrically coupled with a direct current (DC) bus 150. The method can be implemented in the overvoltage protection system 300 of FIGS. 2 and 3 described above.

As illustrated, at block 400 the process starts with verifying whether the overvoltage detection circuit is electrically coupled to the subset of the plurality of energy storage cells by a connection verification circuit. In verifying whether the overvoltage detection circuit is electrically coupled, a controller and/or communication bus may be utilized. Moreover, the method may include communicating that the overvoltage detection circuit is connected and/or communicating that the overvoltage detection circuit is not connected. This may be done internal to the pack, and may utilize an intermediate controller. Verifying whether the overvoltage detection circuit is electrically coupled may also include digitizing and transmitting the communication across a vehicle CAN network.

The process then continues to step 410, detecting an overvoltage condition across a subset of the plurality of energy storage cells by an overvoltage detection circuit. Finally, at block 420 the energy storage pack is electrically decoupled from the DC power bus 150 upon detection of an overvoltage condition across the subset of the plurality of energy storage cells by a disconnect circuit.

According to one embodiment, the method would further include electrically decoupling the energy storage pack from the DC power bus 150 upon the connection verification circuit 250 detecting that the overvoltage detection circuit 240 is not connected to the subset of the plurality of energy storage cells. In addition, the method may include notifying the driver of vehicle, notifying a third party, recording the information on the vehicle, and/or recording the information on a remote server.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments and that the scope of the present invention is accordingly limited by nothing other than the appended claims.

What is claimed is:

1. A system for protecting a hybrid electric vehicle propulsion energy storage pack from an overvoltage condition, the hybrid electric vehicle propulsion energy storage pack including a plurality of energy storage cells electrically connected in series and electrically coupled with a vehicle direct current (DC) bus, the system comprising:
an overvoltage detection circuit configured to detect an overvoltage condition across a subset of the plurality of energy storage cells;
a disconnect circuit configured to electrically decouple the hybrid electric vehicle propulsion energy storage pack from the DC power bus responsive to a detection of an overvoltage condition across the subset of the plurality of energy storage cells; and
a connection verification circuits configured to verify the overvoltage detection circuits are electrically coupled to the subset of the plurality of energy storage cells.

2. The system of claim 1, wherein the plurality of energy storage cells comprises a plurality of ultracapacitors; and,
wherein the hybrid electric vehicle propulsion energy storage pack has a rated voltage of at least 500 volts direct current (VDC).

3. The system of claim 1, wherein the overvoltage detection circuit is powered by the plurality of energy storage cells; and,
wherein the connection verification circuit are powered by the plurality of energy storage cells.

4. The system of claim 3, wherein the connection verification circuit is normally-on when the overvoltage protection circuit is properly connected; and,
wherein a connection fault is identified when the connection verification circuit is faulty or disconnected.

5. The system of claim 1, wherein the connection verification circuit is configured to generate an alert when the connection verification circuit fails to determine whether the overvoltage detection circuit is connected to the plurality of energy storage cells.

6. The system of claim 1, further comprising a controller; and
wherein the connection verification circuit comprises an electrical isolator configured to electrically isolate communications between the connection verification circuit and the controller.

7. The system of claim 1, further comprising a communication bus, wherein at least one of the overvoltage detection circuit and the connection verification circuit is communicably coupled to the communication bus.

8. The system of claim 7, wherein the plurality of energy storage cells are grouped into a plurality of strings, each of the strings having a string positive node and a string negative node.
wherein the overvoltage detection circuit comprises an interface to the string positive node, an interface to the string negative node, a voltage reference electrically coupled to both the string positive node and the string negative node, an on/off device, and an isolator electrically coupled to the on/off device and communicatively multiplexed into the communication bus.

9. The system of claim 8, wherein the on/off device is configured to persistently communicate the overvoltage condition to the communication bus independent of whether the overvoltage condition has ceased.

10. The system of claim 1, wherein the disconnect circuit is further configured to electrically decouple the hybrid electric vehicle propulsion energy storage pack from the DC power bus responsive to a detection that the overvoltage detection circuit is not electrically coupled to the subset of the plurality of energy storage cells.

11. The system of claim 1, wherein the overvoltage detection circuit comprises multiple overvoltage detection circuits configured to detect overvoltage conditions across subsets of the plurality of energy storage cells; and,
wherein the connection verification circuit comprises multiple connection verification circuits coupled in a series circuit with each other such that an indication of at least one of the multiple overvoltage detection circuits not being coupled to the subsets of the plurality of energy storage cells will open the series circuit.

12. The system of claim 11, wherein the multiple connection verification circuits are normally-on when the multiple overvoltage protection circuits are properly connected; and,
wherein a connection fault is identified when at least one of the multiple connection verification circuits is faulty or disconnected.

13. An overvoltage protection system adapted to protect a propulsion energy storage pack for a hybrid electric vehicle, the propulsion energy storage pack including a plurality of energy storage cells grouped into a plurality of strings, each of the strings having a string positive node and a string negative node, an electrical interface with the hybrid electric vehicle coupled to the plurality of energy storage cells and configured to deliver electrical energy to and from the plurality of energy storage cells, the system comprising:
a communication interface with the hybrid electric vehicle;
an energy storage pack communication bus communicatively coupled to the communication interface with the hybrid electric vehicle;
a plurality of overvoltage protection circuits, each of the plurality of overvoltage protection circuits singularly electrically coupled to one of the plurality of strings and communicatively coupled to the energy storage pack communication bus, each of the plurality of overvoltage protection circuits configured to register voltage across it's respective string's string positive node and string negative node, and each of the plurality of overvoltage protection circuits further configured to communicate an overvoltage condition to the energy storage pack communication bus; and
a connection verification circuit configured to verify that each of the plurality of overvoltage protection circuits are electrically coupled to one of the plurality of strings.

14. The overvoltage protection system of claim 13, wherein the plurality of energy storage cells comprises a plurality of ultracapacitors.

15. The overvoltage protection system of claim 13, wherein the propulsion energy storage pack has a rated voltage of at least 500 VDC.

16. The overvoltage protection system of claim 13 wherein the plurality of overvoltage protection circuits, each include an electrical isolator configured to electrically isolate communications between the overvoltage protection circuits and the energy storage pack communication bus.

17. The overvoltage protection system of claim 13 wherein the connection verification circuit is configured to electrically isolate communications between the connection verification circuit and the communication interface with the hybrid electric vehicle.

18. The overvoltage protection system of claim 13 wherein the hybrid electric vehicle includes a vehicle communication bus, the overvoltage protection system further comprising a controller having a processor configured to digitize information communicated over the energy storage pack communication bus; and
wherein energy storage pack communication bus is communicably coupled to the vehicle communication bus via the controller.

19. The overvoltage protection system of claim 18, wherein the processor is further configured to communicate the information communicated over the energy storage pack communication bus according to a standardized communications protocol associated with the vehicle communication bus.

20. The overvoltage protection system of claim 13, further comprising a user interface configured to signal a user upon the occurrence of the overvoltage protection circuit being overvoltage, faulty, and/or disconnected.

21. A method for protecting a hybrid electric vehicle propulsion energy storage pack from an overvoltage condition, the hybrid electric vehicle propulsion energy storage pack including a plurality of energy storage cells electrically connected in series and electrically coupled with a vehicle direct current (DC) bus, the method comprising:
verifying an overvoltage protection circuit is electrically coupled to a subset of the plurality of energy storage cells by a connection verification circuit; and,
communicating that the overvoltage protection circuit is electrically coupled to the subset of the plurality of energy storage cells.

22. The method of claim 21, further comprising:
detecting the overvoltage protection circuit is not electrically coupled to the subset of the plurality of energy storage cells by the connection verification circuit; and,
communicating that the overvoltage protection circuit is not electrically coupled to the subset of the plurality of energy storage cells.

23. The method of claim 22, wherein the communicating that the overvoltage protection circuit is not electrically coupled to the subset of the plurality of energy storage cells comprises communicating over a vehicle CAN network.

24. The method of claim 22, further comprising electrically decoupling the hybrid electric vehicle propulsion energy storage pack from the DC power bus responsive to the communicating that the overvoltage protection circuit is not electrically coupled to the subset of the plurality of energy storage cells.

25. The method of claim 22, further comprising notifying the driver of the vehicle that the overvoltage protection circuit is not electrically coupled to the subset of the plurality of energy storage cells.

26. The method of claim 21, further comprising
detecting an overvoltage condition across the subset of the plurality of energy storage cells by a voltage detection circuit; and,
electrically decoupling the hybrid electric vehicle propulsion energy storage pack from the DC power bus responsive to the detecting the overvoltage condition.
